(19) United States
(12) Patent Application Publication
(10) Pub. No.: US 2025/0314265 A1
(43) Pub. Date: Oct. 9, 2025

(54) FASTENER WITH TOOL-GUIDING TAIL

(71) Applicant: HOWMET AEROSPACE INC., Pittsburgh, PA (US)

(72) Inventors: Robert B. Wilcox, McGregor, TX (US); James Thomas Smith, Crawford, TX (US); Troy Don Pierce, Hewitt, TX (US)

(21) Appl. No.: 18/864,635

(22) PCT Filed: May 26, 2022
(86) PCT No.: PCT/US2022/030991

§ 371 Date: Nov. 11, 2024

(51) Int. Cl. F16B 19/10; B21J 15/02

(52) U.S. Cl. CPC F16B 19/10; B21J 15/022

(57) ABSTRACT

An illustrative example embodiment of a fastener includes a pin having a head and a tail opposite the head. The tail includes a first crest, a second crest and a groove between the first and second crests. The first crest includes a surface on at least one side of the first crest having a first profile. The second crest includes a surface on at least one side of the second crest having a second profile. The second profile is different than the first profile. A pitch between a peak of the first crest and a peak of the second crest is different than a pitch between a root of the first crest and a root of the second crest.

### CROSS-REFERENCE TO RELATED APPLICATIONS

This application is the US national phase of PCT/US2022/030991, which was filed on May 26, 2022, which is incorporated herein by reference in its entirety.

### BACKGROUND

A variety of fasteners are useful for different applications. Some fasteners are installed by cold forming a portion of the fastener, such as a collar or sleeve of a fastener body that is situated on a pin. A tool that grasps and applies tension to the pin provides the force for cold forming the fastener body. Typical tools have a puller with a set of crests and grooves that mate with crests and grooves on a tail of the pin.

If the tool is not properly aligned with the fastener pin, as the puller closes onto the pin, the crests of the puller may collide with the crests on the pin instead of being received into the grooves on the pin. Such crest-to-crest engagement may cause damage to the pin, the tool, or both.

### SUMMARY

An illustrative example embodiment of a fastener includes a pin having a head and a tail opposite the head. The tail includes a first crest, a second crest and a groove between the first and second crests. The first crest includes a surface on at least one side of the first crest having a first profile. The second crest includes a surface on at least one side of the second crest having a second profile. The second profile is different than the first profile. A pitch between a peak of the first crest and a peak of the second crest is different than a pitch between a root of the first crest and a root of the second crest.

In addition to one or more of the features described above, or as an alternative, the surface on the at least one side of the first crest is inclined at a first oblique angle relative to an axis of the pin, the surface on the at least one side of the second crest is inclined at a second oblique angle relative to the axis of the pin, and the second oblique angle is different than the first oblique angle.

In addition to one or more of the features described above, or as an alternative, the surface on the at least one side of the second crest or the surface on the at least one side of the first crest is configured as a camming surface that urges a pulling tool toward the head or the tail as a crest on the pulling tool contacts the surface.

In addition to one or more of the features described above, or as an alternative, the surface on the at least one side of the second crest or the surface on the at least one side of the first crest includes a first segment beginning at a peak of the crest and a second segment between the first segment and a root of the crest, and the first segment and the second segment are inclined at different oblique angles relative to the axis of the pin.

In addition to one or more of the features described above, or as an alternative, the first crest includes a first height that defines a location on the first crest that is most radially distal from an axis of the pin, the second crest includes a second height that defines a location on the second crest that is most radially distal from the axis of the pin, and the second height is different than the first height.

In addition to one or more of the features described above, or as an alternative, the pitch between the peaks of the first and second crests is larger than the pitch between the roots of the first and second crests.

In addition to one or more of the features described above, or as an alternative, an assembly includes the fastener of any preceding paragraph and a tool having a puller including a plurality of puller crests. One of the puller crests is situated to be received in the groove between the first and second crests when the puller is closed onto the tail. That puller crest is longer than at least one other of the puller crests. The groove between the first and second crests is deeper than at least one other groove on the tail.

In addition to one or more of the features described above, or as an alternative, the puller has an interior facing toward the pin, the interior of the puller has a hardness in a range from 53 to 70 HRC, and the pin has a hardness in a range from 32 to 52 HRC.

In addition to one or more of the features described above, or as an alternative, the hardness of the interior of the puller is in a range from 60 to 70 HRC, and the hardness of the pin is in a range from 43 to 50 HRC.

In addition to one or more of the features described above, or as an alternative, a method of installing the fastener of any preceding paragraph includes: situating the fastener body in a desired position relative to a structural component, positioning a puller portion of a tool near the tail, contracting the puller portion until a puller crest contacts one of the first crest or the second crest, and camming the puller crest along the surface on the at least one side of the one of the first crest or the second crest to direct the puller crest into the groove between the first and second crests.

In addition to one or more of the features described above, or as an alternative, the puller portion includes a plurality of puller crests and camming the puller crest along the surface on the at least one side of the one of the first crest or the second crest guides others of the plurality of puller crests into grooves between corresponding others of the plurality of crests on the tail.

An illustrative example embodiment of an assembly includes a fastener and a tool. The fastener has a pin and a fastener body, the pin has a head and a tail opposite the head, the tail includes at least one bearing surface, and the pin has a first hardness. The tool includes a puller having an interior configured to engage the bearing surface for urging at least the tail in a direction along an axis of the pin, a metal on at least the interior of the puller has a second hardness that is harder than the first hardness.

In addition to one or more of the features described above, or as an alternative, the first hardness is in a range from 32 to 52 HRC and the second hardness is in a range from 53 to 70 HRC.

In addition to one or more of the features described above, or as an alternative, the first hardness is in a range from 43 to 50 HRC and the second hardness is in a range from 60 to 70 HRC.

In addition to one or more of the features described above, or as an alternative, the tail includes a first crest, a second crest and a groove between the first and second crests; the at least one bearing surface comprises a plurality of bearing surfaces; each of the bearing surfaces is on at least one side of a corresponding one of the crests; the bearing surface of the first crest has a first profile; the bearing surface of the second crest has a second profile; and the second profile is different than the first profile.

In addition to one or more of the features described above, or as an alternative, the surface on the at least one side of the first crest is inclined at a first oblique angle relative to an axis of the pin, the surface on at least one the side of the second crest is inclined at a second oblique angle relative to the axis of the pin, and the second oblique angle is different than the first oblique angle.

In addition to one or more of the features described above, or as an alternative, the surface on the at least one side of the second crest or the surface on the at least one side of the first crest is configured as a camming surface that urges a pulling tool toward the head as a crest on the pulling tool contacts the surface.

An illustrative example embodiment of a fastener installation tool includes: a tool body; a nose portion near one end of the tool body, the nose portion being configured to be at least partially received over a first type of fastener and a second, different type of fastener, each type of fastener including a fastener pin having at least one bearing surface on a tail of the fastener pin; and a puller supported at least partially within the nose portion to be moveable relative to the tool body for contacting the at least one bearing surface on the tail of either type of fastener and urging at least the tail of the fastener in a direction along an axis of the fastener pin.

In addition to one or more of the features described above, or as an alternative, the tail of the fastener pin includes a plurality of crests including a first crest, a second crest and a groove between the first and second crests, the at least one bearing surface comprises a plurality of bearing surfaces, each of the bearing surfaces is on at least one side of a corresponding one of the crests, the bearing surface of the first crest has a first profile, the bearing surface of the second crest has a second profile, and the second profile is different than the first profile.

In addition to one or more of the features described above, or as an alternative, the bearing surface on the at least one side of the second crest or the bearing surface on the at least one side of the first crest is configured as a camming surface that urges the puller toward the head as a crest on the puller contacts the bearing surface.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates a plurality of fasteners and a fastener installation tool.

FIG. 2 schematically illustrates selected portions of a fastener and a fastener installation tool in a partially sectional view prior to engagement between the tool and the fastener.

FIG. 3 illustrates the features from FIG. 2 showing engagement between the tool and the fastener.

FIG. 4 shows the features from FIG. 2 with crest-to-crest engagement between the tool and the fastener.

FIG. 5 illustrates selected features of an example pin configuration and a corresponding tool configuration.

FIG. 6 illustrates selected dimensional relationships of the example embodiment.

FIG. 7 is a flowchart diagram summarizing an example method of achieving engagement between a tool and a fastener, such as those shown in FIGS. 2 and 3.

### DETAILED DESCRIPTION

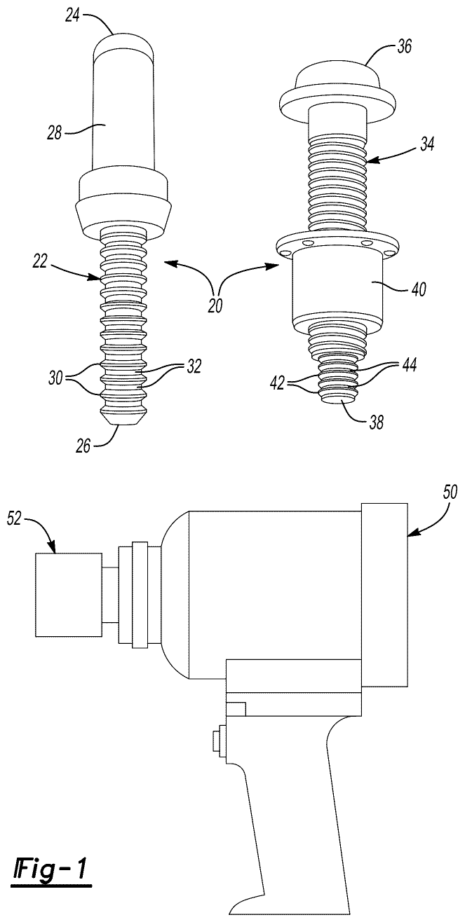

FIG. 1 shows a plurality of fasteners 20 of different types that are useful for different situations. One of the fasteners, which can be referred to as a blind type fastener, includes a pin 22 having a head 24 near one end and a tail 26 opposite the head 24. A fastener body 28, which includes a collar and a sleeve in this example, is received over a portion of the pin 22 between the head 24 and the tail 26. The tail 26 includes a plurality of crests 30 with grooves 32 between adjacent crests 30.

The other fastener illustrated in FIG. 1, which may be referred to as a lock bolt, includes a pin 34. A head 36 is situated near one end of the pin 34 and a tail 38 is opposite the head 36. A fastener body 40, which is a collar in this example, is received over a portion of the pin 34 between the head 36 and the tail 38. The tail 38 includes a plurality of crests 42 with grooves 44 between adjacent crests.

Embodiments of the invention are not necessarily limited to the illustrated example fastener types. For example, the fastener in some embodiments includes a sleeve and a collar integrated into a single fastener body while the fastener in other embodiments includes a collar and a sleeve that are separate pieces.

A fastener installation tool 50 includes a nose assembly 52 that is configured to be compatible with the tail 26 of the blind type fastener and the tail 38 of the lock bolt type fastener. The configuration of the nose assembly 52 makes the tool 50 useable with a variety of fastener types, including those illustrated in FIG. 1.

A puller 54 of the nose assembly 52 is configured to be compatible with the crests 30, 42 and grooves 32, 44 on each type of fastener. The versatility of the nose assembly 52 is unique compared to conventional tools, which are designed for use with one type of fastener. Having a nose assembly 52 that is useful with a variety of fastener types provides efficiencies by reducing operator time for changing tools and requiring less tool inventory.

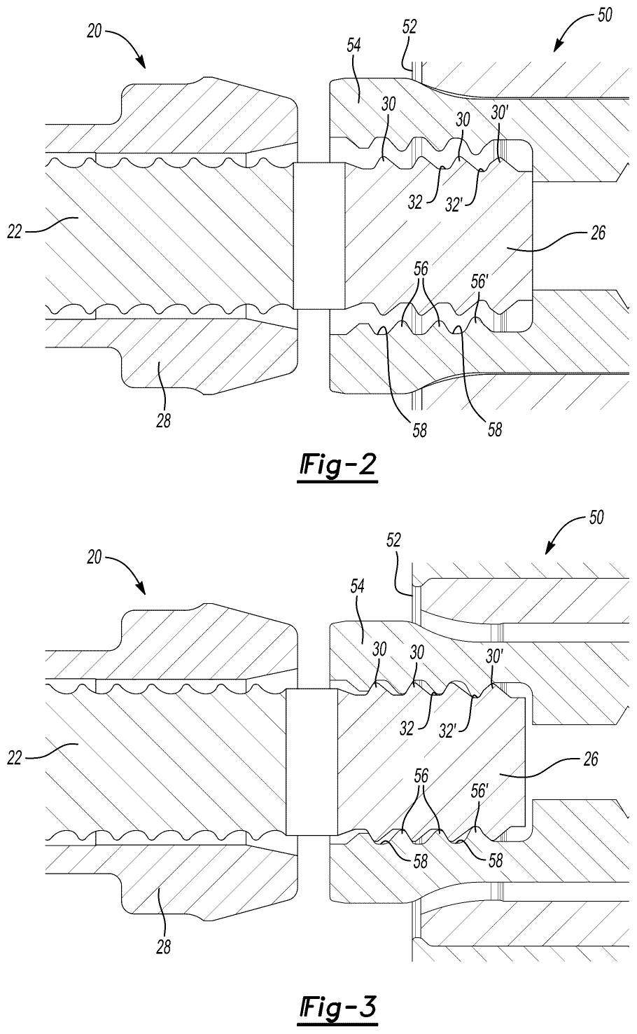

FIGS. 2-5 illustrate a portion of a fastener 20 and a portion of the tool 50. For discussion purposes, the pin 22 and tail 26 of the blind type of fastener is shown in FIGS. 2-5. The illustrated and described features and functions are equally applicable to another type of fastener, such as the lock bolt including the pin 34 and tail 38.

As shown in FIG. 2, the nose assembly 52 of the tool is situated relative to the fastener 20 such that at least a portion of the tail 26 is received within the puller 54. The condition shown in FIG. 2 includes the puller 54 in an expanded or open condition such that the puller 54 and the pin 22 are able to move relative to each other.

In this example, the tail 26 includes a plurality of crests 30 that have a first profile. One of the crests 30′ has a second profile that is different in at least one respect from the first profile. The interior of the puller 54 includes a plurality of crests 56 that are configured to be received within the grooves 32 between the crests 30 on the tail 26. The interior of the puller 54 includes grooves 58 between the crests 56. The grooves 58 are configured to receive the crests 30 on the tail 26 when the puller 54 engages the tail 26. One of the crests 56′ on the interior of the puller has a different configuration compared to the other crests 56 because the crest 56′ is intended to engage the crest 30′ on the tail 26 that has the second profile.

When the puller 54 and the tail 26 are arranged as shown in FIG. 2, it is possible for the puller 54 to close into the position shown in FIG. 3, which corresponds to a desired or proper engagement between the puller 54 and the tail 26 of the pin 22. In this position, the puller 54 can then apply axial tension to the tail 26 for cold forming at least a portion of the fastener body 28 to secure the fastener body 28 in a desired position relative to a structural component or workpiece.

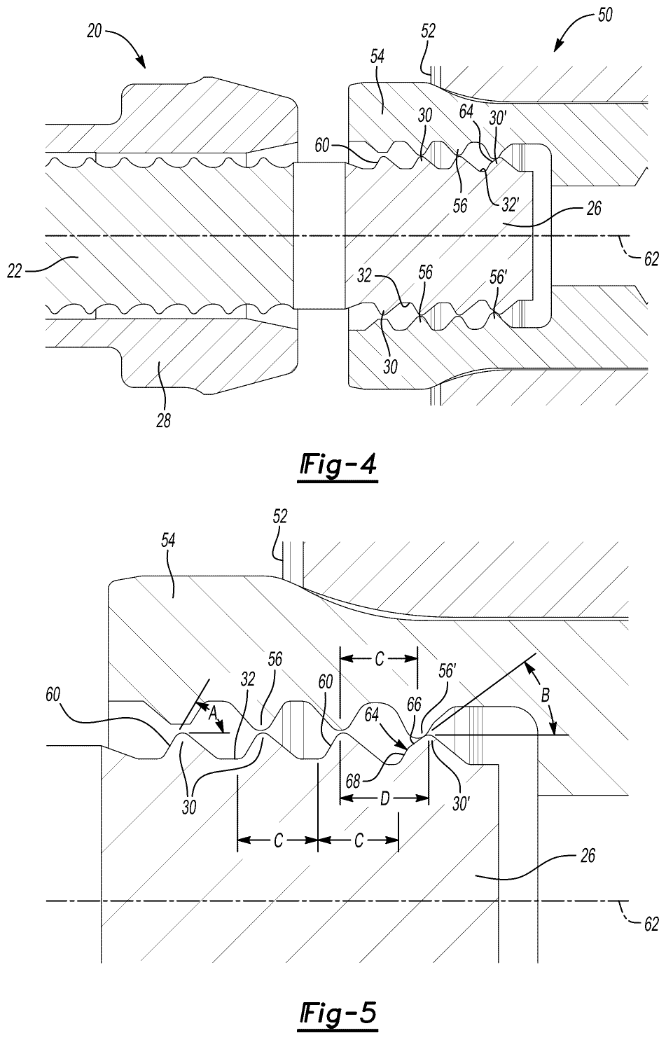

FIG. 4 illustrates a different alignment of the puller 54 and the tail 26. In this alignment or relative position, when the puller 54 closes to engage the pin 26, the crests 56 on the interior of the puller 54 directly contact the crests 30 on the tail 26. Such crest-to-crest engagement between a typical pin and tool does not allow for the puller to properly engage with the tail for purposes of installing the fastener. Under some conditions, crest-to-crest engagement can result in damage to the tool, the pin, or both.

The illustrated example embodiment includes at least one feature that reduces or eliminates the likelihood that the tool and the tail will stay in an undesirable crest-to-crest alignment. The second profile on the crest 30′ on the tail 26 facilitates moving the puller 54 from the undesired position shown in FIG. 4 toward the position shown in FIG. 3 to achieved proper, desired engagement between the puller 54 and the tail 26.

As can be appreciated from FIG. 5, each of the crests 30 includes a bearing surface 60 that is on a side of the crest facing toward the head 24 of the fastener (i.e., facing toward the left according to the drawing). The bearing surfaces 60 are inclined at a first oblique angle A relative to an axis 62 of the pin 22. The oblique angle may vary along the bearing surface 60. For example, some embodiments include a curve along at least some of the bearing surface 60. The oblique angle of such a curved surface corresponds to the orientation of a tangent line at a selected reference point on the curve. The angle will be different relative to the axis 62 of the pin depending on the location along such a bearing surface 60 used as the reference point.

The second, different profile of the crest 30′ includes a bearing surface 64 facing toward the head 24 that is different in at least one respect from the bearing surfaces 60. In this example, the second profile includes the configuration of the bearing surface 64. The illustrated bearing surface 64 includes a first segment 66 beginning at a peak of the crest 30′ and a second segment 68 between the first segment 66 and a root of the crest 30′, which is the location where the crest 30′ and the adjacent groove 32′ meet. At least the first segment 66 is inclined relative to the pin axis 62 at a second oblique angle B.

As can be appreciated from FIG. 5, the first oblique angle A is steeper than the second oblique angle B. The second profile of the surface 64 of the crest 30′ acts as a camming surface. As shown in FIG. 5, the anvil or anvil insert of the nose assembly 52 and the force exerted by the tool 50 close the puller 54 onto the tail 26 and urge the crest 56′ along the surface 64, moving the puller 54 toward the head 24 of the pin 22 (i.e., to the left according to the drawing). The second, different profile of the crest 30′ facilitates moving the puller 54 relative to the pin 22 from the position shown in FIGS. 4 and 5 toward the position shown in FIG. 3. As the crest 56′ follows along the bearing surface 64, the puller 54 moves into a desired engagement with the tail 26 instead of remaining in a crest-to-crest alignment.

Having at least one crest 30′ with a profile that is different than the profile of at least one other crest 30 minimizes or eliminates the likelihood that the puller 54 will remain in a crest-to-crest alignment with the tail 26 as the puller 54 closes onto the tail 26. While the second profile of the surface 64 is provided on the crest 30′ that is closest to the end of the tail 26 in the illustrated example, it is not necessary to have the second, different profile on the crest that is most distal from the head 24 or closest to the end of the tail 26. Other example embodiments include the second, different profile on the crest 30 that is next to the last crest on the tail 26. For example, the crest 30′ will be in the position of the crest 30 that is shown to the left of the crest 30′ in FIG. 5.

The terms “first” and “second” used in this description to refer to a crest or profile are intended to distinguish between them for discussion purposes without placing any limitation on the relative positions of the crests along the length or axis 62 of the tail 26.

As indicated in FIG. 5, the illustrated example embodiment includes a first pitch C between the peaks of the crests 56 and 56′ on the puller 54. The crests 30 that have the first profile may also have the pitch C between the peaks of the crests 30 but that spacing may be different on some fasteners. The pitch C also defines the distance between a location where the root of each crest 30 meets the adjacent groove 32. That dimensional relationship ensures that the peaks of the crests 56 and 56′ on the puller are received in a desired position within a corresponding groove 32 when the puller and the tail are properly engaged (as shown in FIG. 3, for example).

The second profile on the crest 30′ on the tail 26 results in a pitch or spacing D between the peak of the crest 30′ and the peak of the adjacent crest 30. The pitch D is larger than the pitch C. This larger spacing or increased pitch D establishes a mismatch between the peak of the crest 30′ and the corresponding peak of the crest 56′ on the puller even when the rest of the crests 30 are directly aligned with the crests 56 on the puller. The second profile and the different pitch D, therefore, facilitate the crest 56′ on the puller 54 moving along the bearing (and camming) surface 64 as the puller 54 closes onto the tail 26.

The crest 56′ on the puller 54 has an engagement surface configured to be received against the second segment 68 of the bearing surface 64 when the puller is in a closed and engaged position, such as that shown in FIG. 3. The surface contours are set to provide sufficient engagement between the bearing surface on each crest 30, 30′ of the tail 26 and the corresponding crests 56, 56′ of the puller 54.

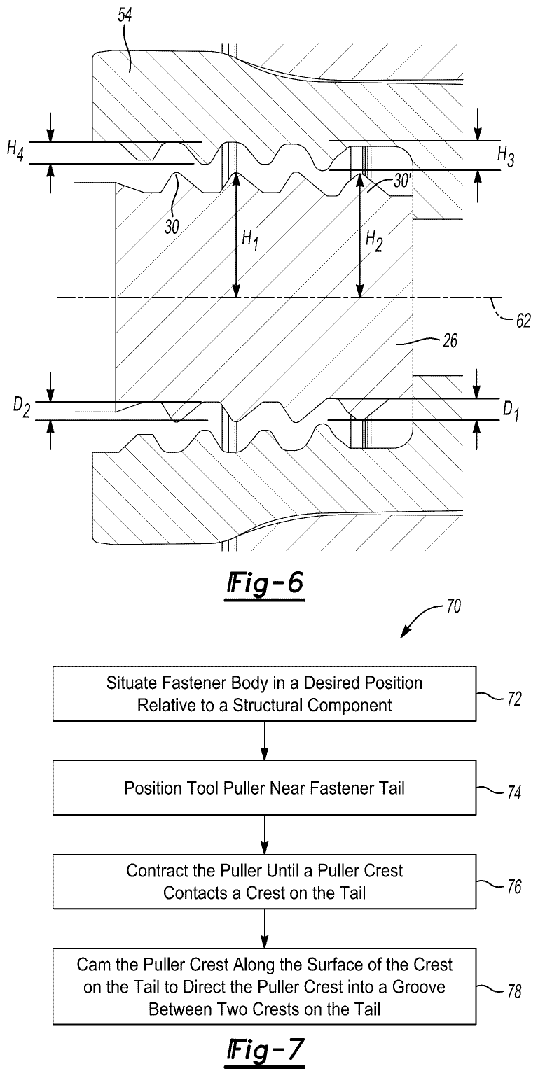

As shown in FIG. 6, the illustrated example embodiment includes another feature that contributes to minimizing or eliminating the likelihood that the puller 54 will remain in a crest-to-crest alignment with the tail 26. In this embodiment, a height H₁ of the crests 30 that include the first profile is greater than a height H₂ of the crest 30′. The height in this context corresponds to a radial distance from the pin axis 62 to the peak of the crest 30, 30′ at the location furthest from the axis 62. The crest 56′ on the puller 54 has a greater height H₃ compared to the height H₄ of the other crests 56 on the puller 54. The heights H₃ and H₄ correspond to different lengths of the crests, with the crest 56′ being longer than the other crests 56 in the illustrated example embodiment.

The greater height or longer length of the crest 56′ ensures that the crest 56′ will engage the crest 30′ prior to or at least simultaneously with the crests 56 potentially engaging the crests 30. This difference in heights of the various crests facilitates the crest 56′ moving along the surface 64 in the event of a misalignment of the puller 54 and the pin 26 as described above.

The grooves respectively have depths that vary in the illustrated example embodiment. The groove adjacent the crest 30′ has a depth D₁ that is greater than a depth D₂ of at least one others of the grooves. In this embodiment, most of the grooves have the same depth D₂. The different groove depths accommodate the different heights H₃ and H₄ of the crests 56′ and 56, respectively, on the puller 54.

Another example embodiment includes the crest 30′ having a larger height than the other crests 30 on the tail 26. When the crest 30′ has a greater height, it will be engaged first by the puller 54 when the tail 26 and the puller 54 are aligned such that crest-to-crest engagement could occur.

FIG. 7 is a flowchart diagram 70 that summarizes a method of overcoming an initial crest-to-crest alignment while installing a fastener having a tail 26 configured like that shown in FIGS. 2-5. At 72, a collar of the fastener is situated in a desired position relative to a structural component, such as being placed within a hole. The tool 50 is situated relative to the fastener at 74 to position the puller 54 near the tail 26 of the fastener. At 76, the puller is contracted until the puller crest contacts a crest on the tail of the fastener. At 78, the puller crest is cammed along the surface of the crest on the tail to direct the puller crest into a groove between two crests on the tail. The camming motion that occurs at 78 urges the puller 54 into the desired alignment with the tail 26, such as that shown in FIG. 3.

The process summarized in FIG. 7 overcomes a crest-to-crest alignment. The illustrated example puller 54 may be in an initial axial alignment with the tail that does not present a risk of crest-to-crest engagement. For example, the crests 56 and 56′ may be directly aligned with the grooves 32 intended to receive the crests on the puller 54 and the puller can close without contacting surfaces on the crests. Another possible alignment may be result in the crests 56 contacting the surfaces on the crests that face toward the end of the tail as the puller 54 closes. The features of the disclosed example embodiments ensure that the puller 54 can fully close in any of those puller-to-pin alignments including the undesirable crest-to-crest alignment.

Another feature of the example embodiment is that at least the interior of the puller 54 is hardened to be harder than any of the fasteners that will be installed using the puller 54. In one example embodiment, the puller 54 undergoes a gas nitride hardening treatment. The gas nitrided metal of the puller 54 is extremely hard. The hardness of at least the interior of the puller 54 that results from the gas nitride in an example embodiment is between 53 and 70 according to the Rockwell hardness scale (i.e., 53 to 70 HRC). In some embodiments, the hardness of at least the interior of the puller 54 is between 60 and 70 HRC.

Having a gas-nitrided puller allows for using pins 22 that are harder than many conventional pins. In some example embodiments, the pin hardness is between 32 and 52 according to the Rockwell hardness scale. In some embodiments, the pin hardness is between 43 and 50 HRC. There are structural advantages to having a pin with such a hardness. A gas-nitrided puller is able to withstand the forces associated with contact between the puller 54 and the tail 26 even when there is crest-to-crest engagement for at least a portion of the fastener installation process. If the puller 54 were not harder than the pin 22, the puller 54 and the tool 50 could be damaged in the event of a crest-to-crest engagement between the puller 54 and the pin 22.

In some example embodiments, the gas nitride treatment applied to the puller 54 results in a gas-nitrided, super hard metal at least on the interior surface of the puller 54 and extending at least partially into the puller components. In some embodiments, the entire puller structure shown in FIGS. 2-5 has the hardness resulting from the gas nitride treatment. In other words, the gas nitride treatment extends through the entire metal of at least the portions of the puller 54 shown in FIG. 2-5.

A fastener tail having crests that include at least one crest with a different profile compared to the profile of at least one other crest and a corresponding difference in pitch between the peaks and roots of the crests reduces or eliminates the likelihood that a puller and the tail will remain in a crest-to-crest engagement during a fastener installation process. The example crest configurations include more than one feature that facilitates ensuring desired engagement between a puller and a fastener tail. At least one of those features may be used in an embodiment to realize the benefits provided by the disclosed example embodiments. Sub-combinations of less than all of those features may be used and those skilled in the art who have the benefit of this description will be able to select which of the features are useful in their particular implementation.

The features described above, such as having at least one crest with a different profile and a gas-nitride treated puller, each contribute to better wear durability and reduced fatigue of the fastener and puller. Avoiding crest-to-crest engagement reduces the wear and fatigue that a puller otherwise would experience over time. Using a harder puller allows for using harder fastener pins, which contributes to enhanced durability of the fastener during and after installation.

More than one embodiment is disclosed above. Any feature of each disclosed embodiment may be combined with at least one feature of another disclosed embodiment to realize further embodiments. Various combinations not specifically described above or illustrated in the drawings are possible and within the scope of this disclosure. Additionally, not every feature of each disclosed embodiment is required in every implementation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fastener, comprising:
a pin including a head and a tail opposite the head,
wherein:
the tail includes a plurality of crests including a first crest, a second crest and a groove between the first and second crests,
the first crest includes a surface on at least one side of the first crest having a first profile,
the second crest includes a surface on at least one side of the second crest having a second profile,
the second profile is different than the first profile, and
a pitch between a peak of the first crest and a peak of the second crest is different than a pitch between a root of the first crest and a root of the second crest.

2. The fastener of claim 1, wherein
the surface on the at least one side of the first crest is inclined at a first oblique angle relative to an axis of the pin,
the surface on the at least one side of the second crest is inclined at a second oblique angle relative to the axis of the pin, and
the second oblique angle is different than the first oblique angle.

3. The fastener of claim 2, wherein the surface on the at least one side of the second crest or the surface on the at least one side of the first crest is configured as a camming surface that urges a pulling tool toward the head or the tail as a crest on the pulling tool contacts the surface.

4. The fastener of claim 2, wherein
the surface on the at least one side of the second crest or the surface on the at least one side of the first crest includes a first segment beginning at a peak of the crest and a second segment between the first segment and a root of the crest, and
the first segment and the second segment are inclined at different oblique angles relative to the axis of the pin.

5. The fastener of claim 1, wherein
the first crest includes a first height that defines a location on the first crest that is most radially distal from an axis of the pin,
the second crest includes a second height that defines a location on the second crest that is most radially distal from the axis of the pin, and
the second height is different than the first height.

6. The fastener of claim 1, wherein the pitch between the peaks of the first and second crests is larger than the pitch between the roots of the first and second crests.

7. An assembly comprising the fastener of claim 1 and a tool having a puller including a plurality of puller crests, wherein
one of the puller crests is situated to be received in the groove between the first and second crests when the puller is closed onto the tail,
the one of the puller crests is longer than at least one other of the puller crests, and
the groove between the first and second crests is deeper than at least one other groove on the tail.

8. The assembly of claim 7, wherein
the puller has an interior facing toward the pin,
the interior of the puller has a hardness in a range from 53 to 70 HRC, and
the pin has a hardness in a range from 32 to 52 HRC.

9. The assembly of claim 8, wherein
the hardness of the interior of the puller is in a range from 60 to 70 HRC, and
the hardness of the pin is in a range from 43 to 50 HRC.

10. A method of installing the fastener of claim 1, the method comprising:
situating the fastener body in a desired position relative to a structural component,
positioning a puller portion of a tool near the tail,
contracting the puller portion until a puller crest contacts one of the first crest or the second crest, and
camming the puller crest along the surface on the at least one side of the one of the first crest or the second crest to direct the puller crest into the groove between the first and second crests.

11. The method of claim 10, wherein the puller portion includes a plurality of puller crests and camming the puller crest along the surface on the at least one side of the one of the first crest or the second crest guides others of the plurality of puller crests into grooves between corresponding others of the plurality of crests on the tail.

12. An assembly, comprising
a fastener including a pin and a fastener body, the pin having a head and a tail opposite the head, the tail including at least one bearing surface, the pin having a first hardness; and
a tool including a puller having an interior configured to engage the bearing surface for urging at least the tail in a direction along an axis of the pin, at least the interior of the puller comprising a metal having a second hardness that is harder than the first hardness.

13. The assembly of claim 12, wherein the first hardness is in a range from 32 to 52 HRC and the second hardness is in a range from 53 to 70 HRC.

14. The assembly of claim 13, wherein the first hardness is in a range from 43 to 50 HRC and the second hardness is in a range from 60 to 70 HRC.

15. The assembly of claim 12, wherein
the tail includes a plurality of crests including a first crest, a second crest and a groove between the first and second crests;
the at least one bearing surface comprises a plurality of bearing surfaces;
each of the bearing surfaces is on at least one side of a corresponding one of the crests;
the bearing surface of the first crest has a first profile;
the bearing surface of the second crest has a second profile; and
the second profile is different than the first profile.

16. The assembly of claim 15, wherein
the surface on the at least one side of the first crest is inclined at a first oblique angle relative to an axis of the pin,
the surface on at least one the side of the second crest is inclined at a second oblique angle relative to the axis of the pin, and
the second oblique angle is different than the first oblique angle.

17. The assembly of claim 16, wherein the surface on the at least one side of the second crest or the surface on the at least one side of the first crest is configured as a camming surface that urges a pulling tool toward the head as a crest on the pulling tool contacts the surface.

18. A fastener installation tool, comprising:
a tool body;
a nose portion near one end of the tool body, the nose portion being configured to be at least partially received over a first type of fastener and a second, different type of fastener, each type of fastener including a fastener pin having at least one bearing surface on a tail of the fastener pin; and
a puller supported at least partially within the nose portion to be moveable relative to the tool body for contacting the at least one bearing surface on the tail of either type of fastener and urging at least the tail of the fastener in a direction along an axis of the fastener pin.

19. The fastener installation tool of claim 18, wherein
the tail of the fastener pin includes a plurality of crests including a first crest, a second crest and a groove between the first and second crests,
the at least one bearing surface comprises a plurality of bearing surfaces,
each of the bearing surfaces is on at least one side of a corresponding one of the crests,
the bearing surface of the first crest has a first profile,
the bearing surface of the second crest has a second profile, and
the second profile is different than the first profile.

20. The fastener installation tool of claim 19, wherein the bearing surface on the at least one side of the second crest or the bearing surface on the at least one side of the first crest is configured as a camming surface that urges the puller toward the head as a crest on the puller contacts the bearing surface.
